(19) United States
(12) Patent Application Publication
(10) Pub. No.: US 2004/0113907 A1
(43) Pub. Date: Jun. 17, 2004

(54) Method and apparatus for supply of power source in liquid crystal display

(75) Inventors: Moo Jin Lee, Daegu (KR); Ki Yol Chong, Kyoungsangbuk-do (KR); Min Hwa Kim, Daegu (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/673,542

(22) Filed: Sep. 30, 2003

(30) Foreign Application Priority Data
Dec. 12, 2002 (KR) P2002-79351

(51) Int. Cl. G09G 3/36; G09G 5/00

(52) U.S. Cl. 345/211; 345/87

(57) ABSTRACT

A method for supplying a power to a liquid crystal display including the steps of reducing a power source voltage from a system and supplying the reduced power source voltage to digital circuit devices for processing digital signal.

This application claims the benefit of Korean Patent Application No. P2002-7935 1 filed in Korea on Dec. 12, 2002, which is herein incorporated by reference.

### BACKGROUND OF THE INVENTION

1. Field of the Invention

The present invention relates to a liquid crystal display, and more particularly to an apparatus and a method for supplying power source in liquid crystal display, which not only lowers the power consumption of a driving circuit but also reduces electromagnetic interference (EMI).

2. Description of the Related Art

In general, a liquid crystal display (LCD) displays a picture by controlling light transmissivity of a liquid crystal cell in accordance with a video signal. Such a liquid crystal display is embodied as an active matrix type device in which a switching device is formed in each cell. Active matrix displays are used in several display apparatuses, such as monitors in computers, an office automation equipment, cellular phones and the like. Typically, a Thin Film Transistor (hereinafter, “TFT”) is used as the switching device in the liquid crystal display of an active matrix type device.

FIG. 1 is a block diagram of a related art liquid crystal display. As shown in FIG. 1, the related art liquid crystal display includes a liquid crystal panel 15 having a set of m×n liquid crystal cells Clc arranged in a matrix, TFTs formed on the areas where the m number of data lines (D1 to Dm) cross the n number of gate lines (G1 to Gn), a data driving circuit 13 to provide data to the data lines (D1 to Dm) of the liquid crystal panel 15 and a gate driving circuit 14 to provide scan signal to the gate lines (G1 to Gn) with scan signal. A timing controller 12 controls the data driving circuit 13 and the gate driving circuit 14 using a synchronous signal generated from an interface circuit 1. A direct current-direct current converter 16 (hereinafter, DC-DC converter) generates voltages to be supplied to the liquid crystal panel 15. A system 10, through a LVDS (a Low Voltage Differential Signaling) transmitter in a graphic controller, supplies the interface circuit 11 with vertical and horizontal synchronous signals, a clock signal and data RGB, and supplies digital circuit devices 11,12,13 and 14 and the DC-DC converter 16 with 3.3V of VCC voltage generated from the power source as a power source voltage.

In the liquid crystal panel 15, a liquid crystal material is injected between two glass substrates. The data lines (D1 to Dm) and the gate lines (G1 to Gn), formed on a lower glass substrate of the liquid crystal panel 15, are formed at right angles with respect to each other. The TFTs are formed on areas adjacent to where the data lines (D1 to Dm) cross the gate lines (G1 to Gn). The TFTs provide data from the data lines (D1 to Dn) to the liquid crystal cells (Clc) in response to scan signals. The gate electrode of a TFT is connected to its corresponding gate line (G1 to Gn) and a source electrode of a TFT is connected to its corresponding data line (D1 to Dm). A drain electrode of a TFT is connected to the pixel electrode of its corresponding liquid crystal cell (Clc).

An upper glass substrate of the liquid crystal panel 15 includes a black matrix (not shown), a color filter and a common electrode formed thereon. Polarizing plates in which optical axes cross each other are respectively attached on the upper and lower glass substrates of the liquid crystal panel 15. An alignment film is formed on the inside of the glass substrate facing the liquid crystal to define a pre-tilt angle of the liquid crystal. Further, the liquid crystal panel 15 includes a storage capacitor Cst in each liquid crystal cell Clc. The storage capacitor Cst is formed between the pixel electrode of the liquid crystal cell Clc and a pre-stage gate line or is formed between the pixel electrode of the liquid crystal cell Clc and a common electrode lines (not shown) to uniformly maintain voltage of the liquid crystal cell Clc.

In response to the data control signal DDC form the timing controller 12, the data driving circuit 13 converts the digital video data RGB into an analog gamma voltage corresponding to a gray level value so as to supply an analog gamma voltage to the data lines (D1 to Dm). The integrated data driving circuit 13 is supplied with 3.3 voltage of VCC voltage as power source voltage. In response to a gate control signal GDC from the timing controller 12, the gate driving circuit 14 supplies scan pulses to the gate lines (G1 to Gn) to select horizontal lines of the liquid crystal panel 15. The gate driving circuit 14 is supplied with a VCC voltage 3.3V as the power source voltage.

The timing controller 12 generates the gate control signal GDC for controlling a gate driving circuit 14 and the data control signal DDC for controlling the data driving circuit 13 using the vertical and horizontal synchronous signals and clock signal from a graphic controller of the system 10 and a clock signal. The gate control signal GDC includes a gate start pulse GSP, a gate shift clock GSC, and a gate output enable signal GOE. The data control signal DDC includes a source start pulse GSP, a source shift clock SSC, a source output enable SOC, and a Polarity POL. The timing controller 12 re-arranges the digital video data RGB provided from the graphic controller of the system 10 to supply the re-arranged digital video data RGB to the data driving circuit 13. A power source voltage VCC of 3.3 V for driving the timing controller 12 is input from the power source of the system 10. Also, the VCC voltage is supplied to the Phase Lock Loop PLL installed in the inside of the timing controller 12. The phase lock loop PLL compares the clock signal to the timing controller 12 with a reference frequency generated from an oscillator(not-shown), regulates frequency of the clock signal under the errors in comparing, and generates a clock signal for sampling the digital video data RGB.

The interface circuit 11 has a LVDS (a Low Voltage Differential Signaling) receiver which functions to lower a voltage level of the signals input from the graphic controller of the system 10 and to reduce the frequency of the signals. Thus, the LVDS reduces the number of the signal lines needed for the system 10 and the timing controller 12. The power source voltage VCC for driving the interface circuit 11 is 3.3V, which is provided by the power source of the system 10. To reduce Electromagnetic interference (hereinafter, EMI) generated by a high frequency component and high voltage of signal supplied from the interface circuit 11 to the timing controller 12, an EMI filter (not-shown) is installed between the interface circuit 11 and the timing controller 12.

The DC-DC converter 16, raises or reduces the 3.3 V of VCC voltage input from the power source of the system 10 to supply voltage to the liquid crystal panel 15. The DC-DC converter 16 includes an output switch device for switching an output voltage to an output group, and a pulse width modulator PWM or a pulse frequency modulator PFM for raising or reducing an output voltage by controlling a control signal duty ratio or frequency of the output switch device. The pulse width modulator raises the output voltage of the DC-DC converter 16 by increasing a controlling signal duty ratio of the output switching device, or lowers the output voltage of the DC-DC converter 16 by decreasing a controlling signal duty ratio of the output switching device. The pulse frequency modulator raises the output voltage of the DC-DC converter 16 by increasing a controlling signal frequency of the output switching device, or lowers the output voltage of the DC-DC converter 16 by decreasing a controlling signal frequency of the output switching device.

The output voltage of the DC-DC converter 16 has a voltage VDD that is higher than 6V, a gamma reference voltage GMA1˜10 of 1˜10V, a common voltage VCOM of 2.5˜3.3V, a gate high voltage VGH voltage that is higher than 15V, and a gate low voltage VGL under−(minus) 4V. The gamma reference voltage GMA1˜10 can be generated by dividing the VDD voltage. The VDD voltage and the gamma reference voltage GMA1˜10 are applied to the data driving circuit 13 as the analog gamma voltage. The common voltage VCOM is supplied to a common electrode formed on the liquid crystal panel 15 and to the data driving circuit 13. The gate high VGH is a logic high voltage of a scan pulse established higher than on-voltage which is supplied to the gate driving circuit 14, and the gate low VGL voltage, which is supplied to the gate driving circuit 14, is a logic low voltage of a scan pulse provided as TFT's off-voltage.

The related art liquid crystal display, however, has the problem of high power consumption in driving circuit of the liquid crystal display and in the system 10. Further, the related art liquid crystal display also has high EMI because the voltage input from the system 10 necessary to drive the driving circuit of the liquid crystal display is high. Furthermore, as described above, the related art liquid crystal employs additional circuits to shield the EMI, which increases the cost of the liquid crystal display.

### SUMMARY OF THE INVENTION

Accordingly, it is an object of the present invention to provide a power supplying apparatus and method for use in a liquid crystal display that is adaptive for reducing EMI.

Another object of the present invention is to lower the power consumption of the driving circuit in a liquid crystal display.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for supplying a power to a liquid crystal display according to one aspect of the present invention includes the steps of reducing a power source voltage from a system and supplying the reduced power source voltage to digital circuit devices for processing digital signal.

In another aspect, an apparatus for supplying a power of a liquid crystal display includes a voltage reducing circuit for reducing a power source voltage from a system and a digital circuit device for conducting digital signal driven by the reduced power source voltage.

In another aspect, an apparatus for supplying a power of a liquid crystal display includes a system for generating a power voltage under 3.0V; and at least one of digital circuit devices used to process digital signals for taking the power voltage.

It is to be understood that both the foregoing general description and the following detailed description are exemplary and explanatory, and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a related art liquid crystal display.

FIG. 2 is a detailed block diagram showing a transmission path of power voltage shown in FIG. 1.

FIG. 3 is a block diagram showing a liquid crystal display according to a first embodiment of the present invention.

FIG. 4 is a detailed block diagram showing a transmit path of power voltage shown in FIG. 3.

FIG. 5 is circuit diagram showing a first example of the voltage reducing circuit shown in FIG. 3.

FIG. 6 is circuit diagram showing a second example of the voltage reducing circuit shown in FIG. 3.

FIG. 7 is circuit diagram showing a third example of the voltage reducing circuit shown in FIG. 3.

FIG. 8 is circuit diagram showing a fourth example of the voltage reducing circuit shown in FIG. 3.

FIG. 9 is circuit diagram showing a fifth example of the voltage reducing circuit shown in FIG. 3.

FIG. 10 is a block diagram showing a liquid crystal display according to a second embodiment of the present invention.

FIG. 11 is a detailed block diagram showing a transmission path of power voltage shown in FIG. 10.

FIG. 12 is a graph indicating the relationship of EMI and the frequency when the 2.5 V of power voltage is supplied to a driving circuit in a sample LCD.

FIG. 13 is graph indicating the relationship of EMI and the frequency when the 2.85V of power voltage is supplied to a driving circuit in a sample LCD.

### DETAILED DESCRIPTION OF THE PREFERRED EMBODIMENTS

Reference will now be made in detail to the preferred embodiments of the present invention, examples of which are illustrated in the accompanying drawings.

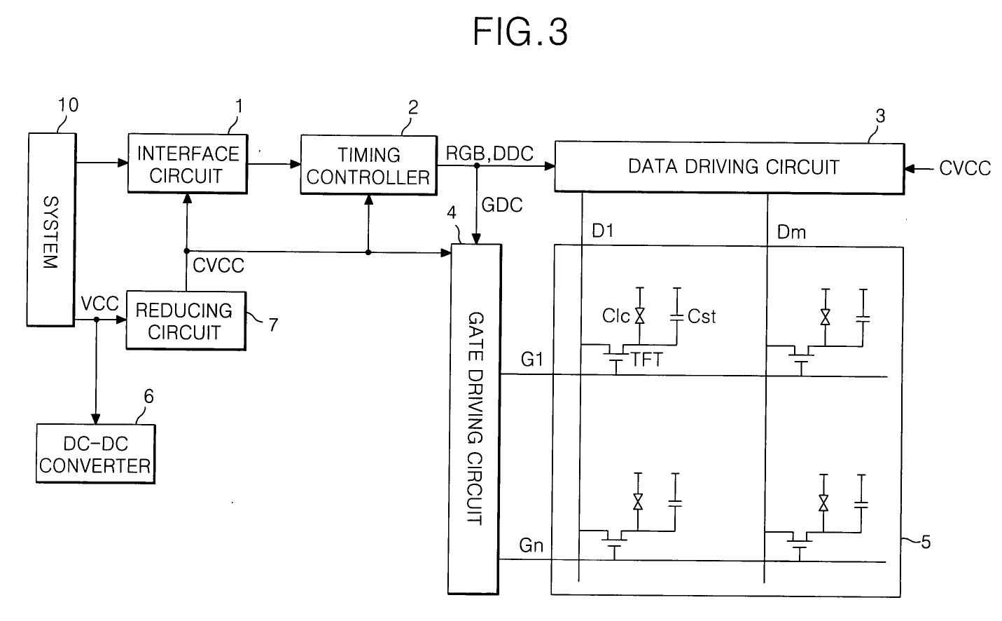

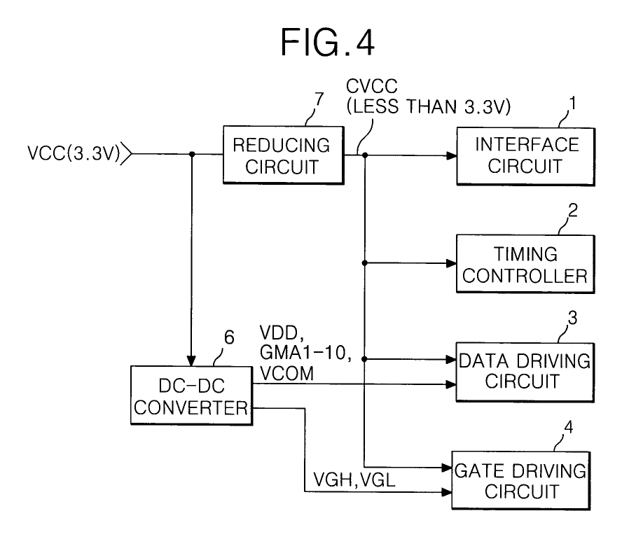

FIG. 3 is a block diagram showing a liquid crystal display according to a first embodiment of the present invention. FIG. 4 is a detailed block diagram showing a transmit path of power voltage shown in FIG. 3. Referring to FIGS. 3 and 4, a liquid crystal display according to a first embodiment of the present invention, includes a liquid crystal panel 5, a data driving circuit 3 for providing data to data lines (D1 to Dm) of a liquid crystal panel 5, a gate driving circuit 4 for providing scan signal to gate lines (G1 to Gn), a timing controller 2 for controlling the data driving circuit 3 and the gate driving circuit 4 using a synchronous signal from an interface circuit 1, a DC-DC converter 6 for generating voltage to be supplied to the liquid crystal panel 5, and a voltage reducing circuit 7 for reducing VCC voltage supplied from system 10. Through the LVDS transmitter of a graphic controller, a system 10 provides clock signal and RGB data to an interface circuit 1 vertical and horizontal synchronous signals, and provides a VCC voltage of 3.3V generated from the power source as a power source voltage to the reducing voltage circuit 7 and the DC-DC converter 6.

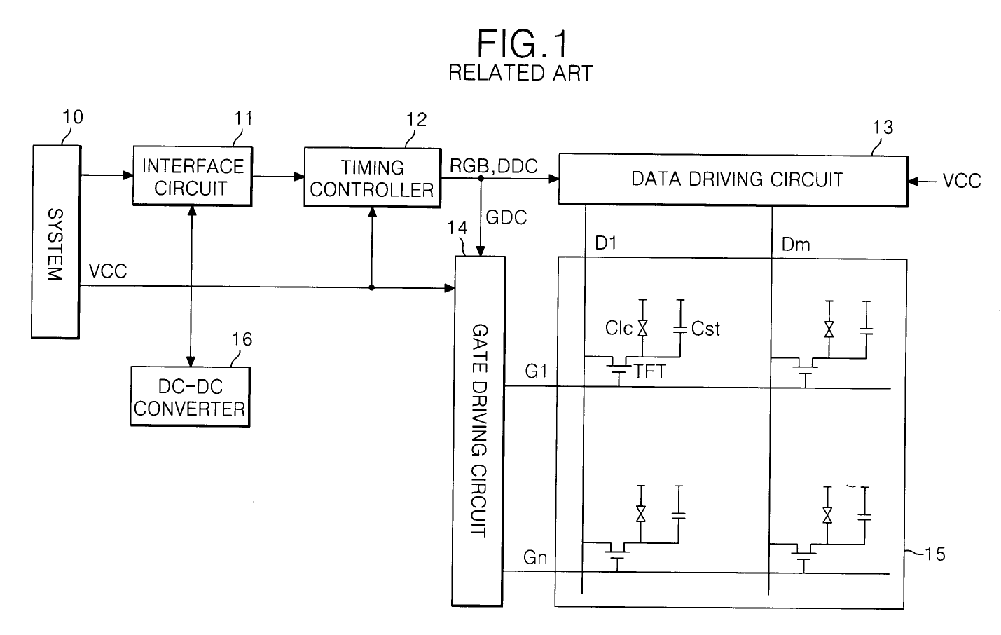

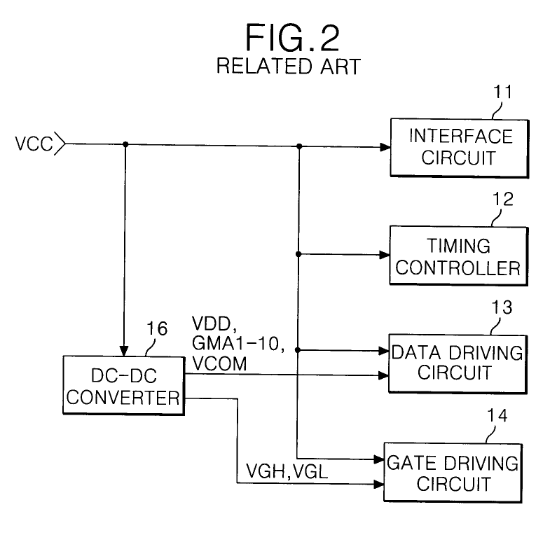

The liquid crystal panel 5 in FIGS. 3 and 4 is substantially the same as that shown in FIG. 1, and thus the detailed description of the liquid crystal panel 5 will not be repeated. A data driving circuit 3, in response to the data control signal DDC from the timing controller 2, converts the digital video data RGB into an analog gamma voltage to provide the analog gamma voltage to the data lines (D1 to Dm). The data driving integrated circuit has an integrated data driving circuit 3 that supplies a VCC voltage of 3.0V as a power source voltage. Therefore, the data driving circuit 3 is driven by a voltage of less than 3.0V.

In response to the gate control signal GDC from the timing controller 2, a gate driving circuit 4 supplies the scan pulse sequentially to gate lines (G1 to Gn), to select the horizontal line of the liquid crystal panel 5. The gate driving integrated circuit has an integrated gate driving circuit 4 supplying a voltage CVCC that is less than 3.3V or 3.0V as the power source voltage. Therefore, the gate driving circuit 4 is driven by a low voltage, which is less than 3.0V.

The timing controller 2 generates, through the interface circuit 1, a gate control signal GDC for controlling the gate driving circuit 4 and a data control signal DDC for controlling the data driving circuit 3 using the vertical and horizontal synchronous signals and the clock signal inputted from a graphic controller of a system 10. The timing controller 2 re-arranges the digital video data RGB inputted from the graphic controller of a system 10 through the interface circuit 1, and supplies the digital video data RGB to the data driving circuit 3. A power source voltage CVCC for driving the timing controller 2, inputted from the power source of the system 10, is less than 3.3V or 3.0V. Also, the power source voltage CVCC is supplied to the Phase Lock Loop PLL installed in the inside of the timing controller 2, as a power source voltage. Therefore, the timing controller 2 is driven by a low voltage, which is less than 3.0V.

The interface circuit 1 has a LVDS receiver, which lowers a voltage level of the signals input from the graphic controller of the system 10 and to raise the frequency, to thereby reduce the number of the signal lines needed to the system 10 and the timing controller 2. The power source voltage necessary for driving the interface circuit 1 is supplied with a CVCC voltage less than 3.3V or 3.0V. Therefore, the interface circuit 1 is driven by the low voltage less than 3.0V. The interface circuit 1 can be installed in the timing controller 2.

The DC-DC converter 6, through a connector (not shown), generates a VDD voltage higher than 6V, a VCOM voltage of 2.5V˜3.3V, a gamma reference voltage GMA1˜10 of 1˜10V, a VGH voltage higher than 15V, and a VGL voltage lower than −(minus)4V, by raising or reducing VCC voltage of 3.3V input from the power source of the system 10. The DC-DC converter 6 includes an output switch device for switching an output voltage on output end, and includes a pulse width modulator PWM or a pulse frequency modulator PFM for raising or reducing an output voltage by controlling the duty ratio or frequency of the controlling signal of the output switching device.

The VDD voltage, the VCOM voltage, gamma reference voltages GMA1˜10, the VGH voltage and the VGL voltage, all of which are supplied from the DC-DC converter 6, are provided to the liquid crystal panel 5. The VDD voltage is a voltage corresponding to the highest gray level or the lowest gray level for the data, which is supplied to the pixel electrode of the liquid crystal cell Clc through the data lines (D1 to Dm). The gamma reference voltage GMA1˜10 are voltages corresponding to middle gray levels, which is supplied to the pixel electrode of the liquid crystal cell Clc through the data lines (D1 to Dm). The VGH voltage is a logic high voltage of the scan pulse and is supplied to the gate lines (G1 to Gn) of the liquid crystal panel 5, and the VGL voltage is a logic low voltage of scan pulse and is supplied to the gate lines (G1 to Gn) of the liquid crystal panel 5. Therefore, the DC-DC converter 6 according to the first embodiment of the present invention has an interchangability with the conventional DC-DC converter because the present DC-DC converter 6 is the same as the conventional DC-DC converter.

A voltage reducing circuit 7 reduces the VCC voltage of 3.3V supplied from the power source of the system 10 to provide a reduced voltage to the digital circuit devices, such as the interface circuit 1, the timing controller 2, the data driving circuit 3 and the gate driving circuit 4, which recognize a logic high value and a logic low value of the digital signal supplied thereto. The voltage reducing circuit 7, which is comprised of a pulse width modulator, a pulse frequency modulator, a regulator, a low drop out controller, a resistance, a capacitor, etc., reduces the VCC voltage. The voltage reducing circuit 7 may reduce the power source voltage necessary to only a part of digital circuit devices. For example, the voltage reducing circuit 7 may supply the reduced CVCC voltage to the interface circuit 111 and the timing controller 112 while directly supplying the VCC voltage to the data driving circuit 113 and the gate driving circuit 114 without reducing the VCC voltage.

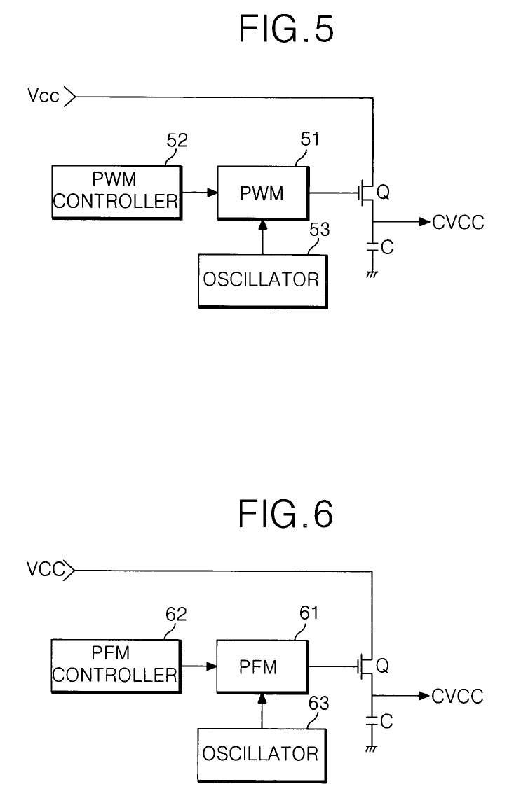

FIG. 5 is circuit diagram showing a first example of the voltage reducing circuit shown in FIG. 3. Referring to the FIG. 5, the voltage reducing circuit 7 includes an output switching device Q for switching an output voltage, a pulse width modulator 51 for reducing the output voltage by controlling the duty ratio of the control signal provided to the control terminal of the output switching device Q, an oscillator 53 for generating a reference frequency, and a PWM controller 52 for controlling the pulse width modulator 51. The pulse width modulator 51 controls the on/off timing of the switching device Q by controlling the duty ratio of the reference frequency inputted from the oscillator 53 under controlling of the PWM controller 52, to thereby control the voltage level of the CVCC voltage. In other words, lowering the duty ratio of the controlling signal lowers the voltage level of the CVCC voltage. The PWM controller 52 supplies the controlling signal indicating the duty ratio to the pulse width modulator 51 to control the pulse width modulator 51. The capacitor C stores the CVCC voltage connected to the output end, and controls the voltage change of the output end.

FIG. 6 is circuit diagram showing a second example of the voltage reducing circuit shown in FIG. 3. Referring to the FIG. 6, the voltage reducing circuit 7 includes an output switching device Q for switching an output voltage, a pulse frequency modulator 61 for reducing an output voltage by controlling duty ratio of the controlling signal supplied to the control terminal of the output switching device Q, an oscillator 63 for generating a reference frequency, and a PFM controller 62 for controlling the pulse width modulator 61. The pulse frequency modulator 61 controls the on/off timing of the switching device Q by controlling the standard frequency inputted from the oscillator 63 under controlling of the PFM controller 62, and the pulse frequency modulator 61 controls the voltage level of the CVCC voltage. In other words, when the frequency of the controlling signal is lowered, the voltage level of the CVCC voltage is lowered. Thus, the PFM controller 62 controls the pulse frequency modulator 61 by supplying the control signal representing frequency to the pulse frequency modulator 61. The capacitor C stores the CVCC voltage connected to the output end, and controls the voltage changes in the output.

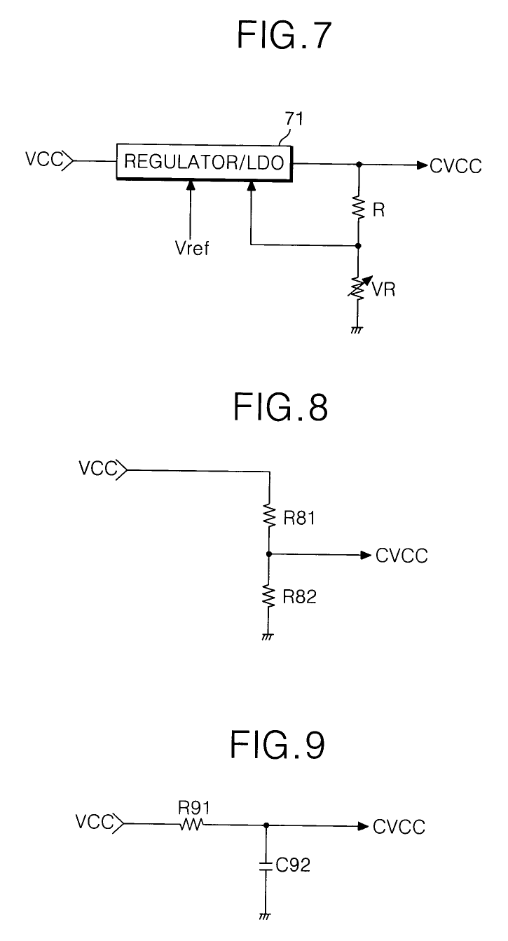

FIG. 7 is circuit diagram showing a third example of the voltage reducing circuit shown in FIG. 3. Referring to the FIG. 7, the voltage reducing circuit 7 includes a regulator or a low drop out controller 71. The regulator or the low drop out controller 71 compares an output voltage with a reference voltage Vref. As a result of the comparison, if there is a difference, the regulator or the low drop out controller 71 controls a switching device (not shown) therein to generate the CVCC voltage, which is reduced from the VCC voltage. In connection with the regulator or low drop-out controller 71, the voltage level of the CVCC voltage is regulated by controlling a variable resistance value VR of the voltage-dividing resist or R, or the reference voltage Vref.

FIG. 8 is circuit diagram showing a fourth example of the voltage reducing circuit shown in FIG. 3. Referring to the FIG. 8, the voltage reducing circuit 7 includes voltage-dividing resistors R81 and R82. The voltage-dividing resistors R81 and R82 reduce the VCC voltage according to the voltage-dividing ratio defined by their respective resistance values. When the resistance values of the voltage dividing resistors R81 and R82 are adjusted, the voltage level of the CVCC voltage is controlled accordingly.

FIG. 9 is circuit diagram showing a fifth example of the voltage reducing circuit shown in FIG. 3. Referring to FIG. 9, the voltage reducing circuit 7 includes a capacitor C92 connected between a ground power source (voltage source GND) and an output end. The capacitor C92 charges the VCC voltages corresponding to its capacitance value and then discharges the charged voltage, to produce the CVCC voltage. By controlling the capacitance of the capacitor C92, the voltage level of the CVCC voltage is regulated. The resistor R91 connected directly between the input and the output ends, is used to restrict an electric current.

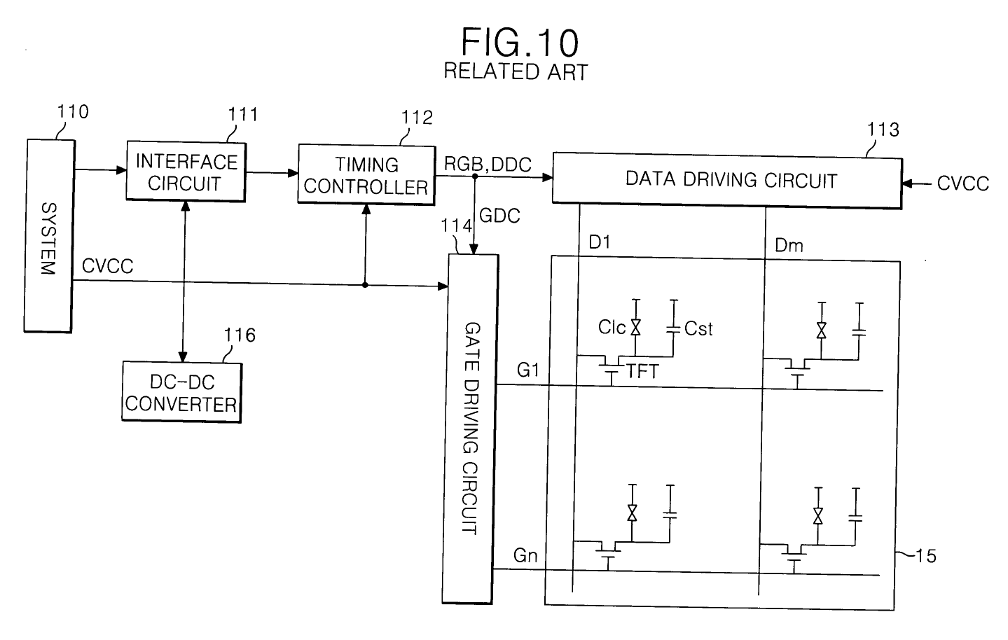

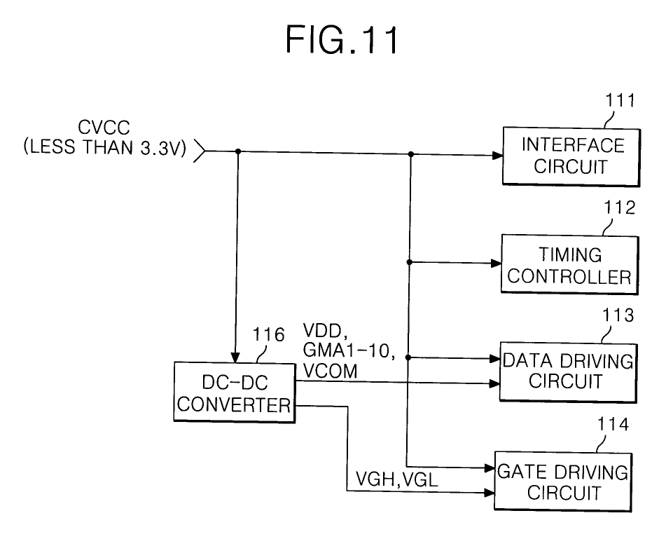

FIG. 10 is a block diagram showing a liquid crystal display according to a second embodiment of the present invention. FIG. 11 is a detailed block diagram showing a transmission path of power voltage shown in FIG. 10. Referring to the FIG. 10 and FIG. 11, a liquid crystal display according to a second embodiment of the present invention includes a liquid crystal panel 115, a data driving circuit 113 for supplying data to the data lines (D1 to Dm), a gate driving circuit 114 for supplying scan pulse to the gate lines (G1 to Gn), a timing controller 112 for controlling the data driving circuit 113 and the gate driving circuit 114 using a synchronous signal from the interface circuit 111, and a DC-DC converter 116 for generating the voltage supplied to the liquid crystal panel 115.

A system 110, through the LVDS transmitter of the graphic controller, supplies an interface circuit 111 with vertical and horizontal synchronous signals, a clock signal and data RGB and supplies the digital circuit devices 111,112,113, and 114 and the DC-DC converter 116 with the CVCC voltage less than 3.0V generated from a power source. A liquid crystal panel 115 is substantially same as that shown in the FIG. 3. A data driving circuit 113, in response to the data control signal DDC from the timing controller 112, converts the digital video data RGB into analog gamma voltages corresponding to gray level values, and the data driving circuit 113 supplies the data lines (D1 to Dm) with the analog gamma voltages. The data driving integrated circuit in the data driving circuit 113 is supplied with the CVCC voltage less than 3.0V as a power source voltage.

A gate driving circuit 114, in response to the gate control signal GDC from the timing controller 112, selects the horizontal line of the liquid crystal panel 115 supplied with data by selecting gate lines (G1 to Gn) with the scan pulse sequentially. The gate driving integrated circuit in the gate driving circuit 114 is supplied with the CVCC voltage less than 3.0V as the power source voltage. A timing controller 112 generates, throughout an interface circuit 111, a gate control signal GDC for controlling a gate driving circuit 114 and a data control signal DDC for controlling a data driving circuit 113 using vertical and horizontal synchronous signals input from a graphic controller of a system 110 and a clock signal. The timing controller 112 re-arranges the digital video data RGB input from the graphic controller of a system 110, through the interface circuit 111, and supplies the digital video data RGB to the data driving circuit 113.

A power source voltage CVCC for driving the timing controller 112 of less than 3.0V is input from the power source of the system 110. Also, the CVCC voltage is supplied to the Phase Lock Loop PLL installed in the inside of the timing controller 112, as a power source voltage.

The interface circuit 111 can reduce the number of the signal lines needed between the system 110 and the timing controller 112, with a LVDS receiver, by lowering a voltage level of the signals input from the graphic controller of the system 110 and by increasing the frequency. The power source voltage CVCC for driving the interface circuit 111 is supplied with the voltage less than 3.0V input from the power source of the system 10. The interface circuit 111 can be installed in the inside of the timing controller 112.

A DC-DC converter 116, through a connector (not-shown), generates the VDD voltage of more than 6V, the VCOM voltage of the 2.5˜3.3V, the gamma standard voltages GMA1˜10 of 110V, the VGH voltage of more than 15V, and the VGL voltage of less than −(minus) 4V by raising or reducing the CVCC voltage from the 3.0V input from the power source of the system 10. To this end, the DC-DC converter 116 includes an output switching device for switching an output voltage on output group, and includes a pulse width modulator PWM or a pulse frequency modulator PFM for raising or reducing an output voltage by controlling a control signal duty ratio or frequency of the output switching device. The VDD voltage, the VCOM voltage, the gamma standard voltages GMA1˜10, the VGH voltage and the VGL voltage output from the DC-DC converter 116 are supplied to the liquid crystal panel 15.

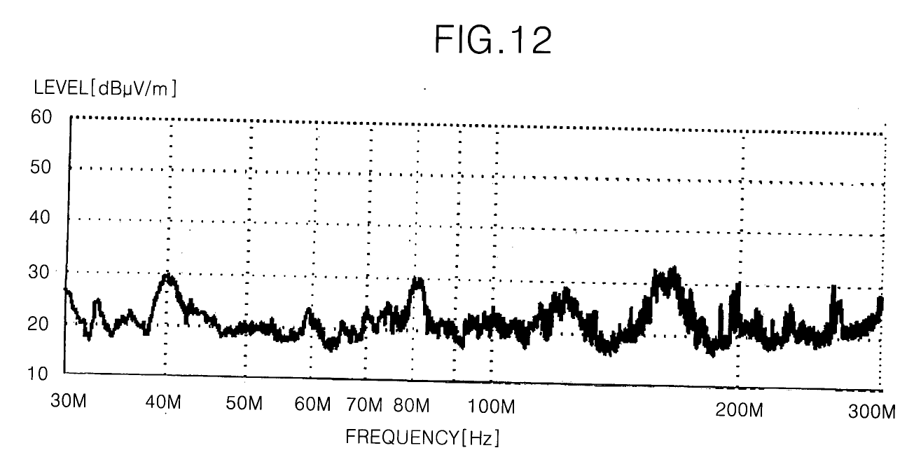

FIG. 12 is a graph indicating the relationship of EMI and the supply voltage when the 2.5 V of power voltage is supplied to a driving circuit in a sample LCD. A sample liquid crystal panel which is used in the experiment has such characteristics as the following table 1.

TABLE 1

| | | | |
|---|---|---|---|
| Model | LP150 × 05 | Test pattern | Winfcc H |
| Resolution | 1024 × 768 | Interface receiver | ESCS 30 |
| TEST PC | DELL | Test site | LG.Philips LCD 3 m |
| | | | CH |

FIG. 12 shows the relationship of the EMI and the frequency power consumption when the 2.5V of the power source voltage is supplied to the driving circuit of the sample liquid crystal display shown in the table 1.

Table 2 is measured values of the EMI according to the frequency of the power source voltage of the 2.5V.

TABLE 2

| Frequency(MHz) | EMI(dBμV/m) |
|---|---|
| 50.76 | 20.88 |
| 53.64 | 21.62 |
| 59.52 | 23.75 |
| 65.40 | 21.41 |
| 74.28 | 25.33 |
| 81.12 | 30.07 |
| 82.80 | 24.57 |
| 97.80 | 23.70 |
| 100.08 | 24.84 |
| 118.92 | 27.84 |
| 122.16 | 28.91 |
| 132.60 | 24.46 |
| 157.08 | 32.58 |
| 166.08 | 33.23 |
| 174.24 | 28.93 |
| 199.92 | 30.54 |
| 210.36 | 25.51 |
| 229.08 | 25.02 |
| 262.56 | 30.37 |
| 298.32 | 28.28 |

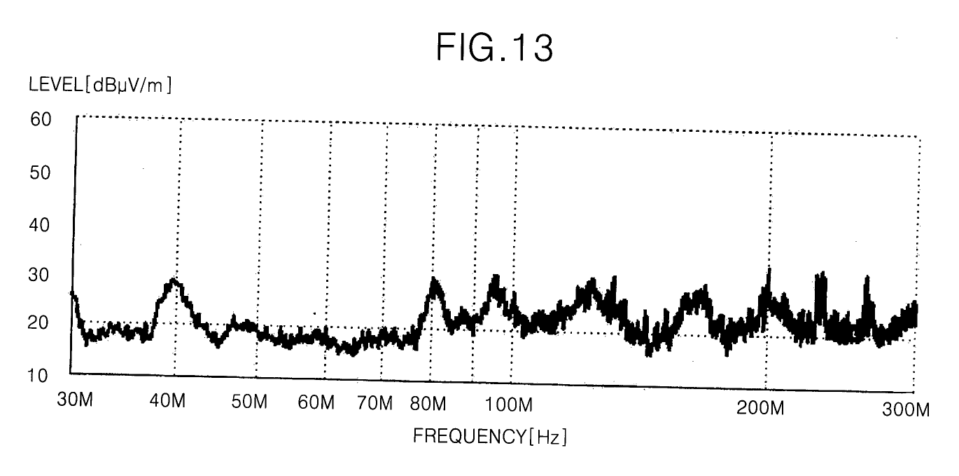

The FIG. 13 is showing the relationship of the EMI and the frequency when the 2.85V of the power source voltage is supplied to the driving circuit of the sample liquid crystal display described in the table 1.

The table 3 is measured values of the EMI according to the frequency of the power source voltage of the 2.85V.

TABLE 3

| Frequency(MHz) | EMI(dBμV/m) |
|---|---|
| 48.48 | 20.94 |
| 53.16 | 19.91 |
| 60.00 | 19.83 |
| 67.32 | 19.53 |
| 72.36 | 20.15 |
| 80.16 | 30.09 |
| 82.68 | 25.41 |
| 95.52 | 30.96 |
| 100.20 | 27.46 |
| 118.92 | 29.09 |
| 123.96 | 30.07 |
| 131.28 | 31.21 |
| 157.44 | 25.65 |
| 168.12 | 29.94 |
| 176.40 | 24.16 |
| 199.92 | 33.56 |
| 208.56 | 28.62 |
| 228.24 | 30.00 |
| 262.56 | 32.35 |
| 298.20 | 27.55 |

As described above, the method and apparatus for supplying power source to the liquid crystal display according to the present invention, performs to reduce the 3.3V of the power source voltage generated from the system to a voltage less than 3.0V, to supply the reduced power source voltage to the digital circuit devices for processing the digital signal, or to supply the voltage less than 3.0V generated in the power source of the system to the digital circuit devices and the DC-DC converter as the power source voltage. Therefore, the method and apparatus for supplying power source to the liquid crystal display according to the present invention, drive the liquid crystal display with a low consume power as low as the power source voltage and reduce the EMI. Further, the method and apparatus of the liquid crystal display according to the present invention, is free of the EMI filter due to the reduced the EMI.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A method for supplying a power to a liquid crystal display, comprising the steps of:
reducing a power source voltage from a system; and
supplying the reduced power source voltage to digital circuit devices for processing digital signal.

2. The method for supplying with a power of a liquid crystal display according to claim 1, wherein the power source voltage from the system is over 3.0V.

3. The method for supplying with a power of a liquid crystal display according to claim 1, wherein the reduced power voltage is under 3.0V.

4. The method for supplying with a power of a liquid crystal display according to claim 1, further comprising the step of:
raising or reducing the power source voltage from the system to generate voltage to be supplied to the liquid crystal panel.

5. A method for supplying a power of a liquid crystal display, comprising the steps of:
taking a power source voltage less than 3.0V from a system.
supplying the power source voltage to the digital circuit devices for processing digital signal.

6. The method for supplying with a power of a liquid crystal display according to claim 5, further comprising the steps of:
raising or reducing the power source voltage from the system to generate voltage to be supplied to the liquid crystal panel.

7. An apparatus for supplying with a power of a liquid crystal display, comprising:
a voltage reducing circuit for reducing a power source voltage from a system; and
a digital circuit device for conducting digital signal driven by the reduced power source voltage.

8. The apparatus for supplying with a power of a liquid crystal display according to claim 7, wherein the power source voltage input from the system is over 3.0V.

9. The apparatus for supplying a power of a liquid crystal display according to claim 7, wherein the reduced power source voltage is under 3.0V.

10. The apparatus for supplying a power of a liquid crystal display according to claim 7, further comprising a DC-DC converter for raising or reducing the power source voltage from the system to generate the raised or the reduced voltage to be supplied to the liquid crystal panel.

11. The apparatus for supplying with a power to a liquid crystal display according to the claim 7, wherein the digital circuit device comprising:
an interface circuit for receiving a synchronous signal, a clock signal and digital video data from the system;
a data driving circuit for supplying the digital video data to the liquid crystal panel;
a gate driving circuit for supplying a scan pulse to the liquid crystal panel; and
a timing controller for controlling the data driving circuit and the gate driving circuit by using the synchronous signal and the clock signal from the interface circuit.

12. The apparatus for supplying with a power to a liquid crystal display according to claim 10, wherein the DC-DC converter generates a VDD voltage over 6V, a gamma reference voltage generated by voltage-dividing the VDD voltage, and VCOM voltage of 2.5 to 3.3V.

13. The apparatus for supplying with a power to a liquid crystal display according to claim 7, wherein the voltage reducing circuit includes:
an output switching device;
a control signal generator for generating a control signal to the output switching device; and
a pulse width modulator for modulating the duty ratio of the control signal.

14. The apparatus for supplying with a power to a liquid crystal display according to claim 7, wherein the voltage reducing circuit includes:
an output switching device;
a control signal generator for generating a control signal to the output switching device; and
a pulse frequency modulator for modulating the frequency of the control signal.

15. The apparatus for supplying with a power of a liquid crystal display according to claim 7, wherein the voltage reducing circuit includes:
a regulator for reducing the power source voltage from the system based on the comparison of the predetermined reference voltage and the output voltage.

16. The apparatus for supplying with a power to a liquid crystal display according to claim 7, wherein the voltage reducing circuit includes:
a resistor for voltage-dividing the power source voltage from the system.

17. The apparatus for supplying a power of a liquid crystal display according to claim 7, wherein the voltage reducing circuit includes:
a capacitor for charging and discharging the power source voltage from the system.

18. An apparatus for supplying a power of a liquid crystal display comprising:
a system for generating a power voltage under 3.0V; and
at least one of digital circuit devices used to process the digital signal for taking the power voltage.

19. The apparatus for supplying a power of a liquid crystal display according to claim 18, further comprising a DC-DC converter for raising or reducing the power source voltage to generate the raise or the reduced voltage to be supplied to the liquid crystal panel.

20. The apparatus for supplying with a power of a liquid crystal display according to claim 18, wherein the digital circuit devices include:
an interface circuit for receiving a synchronous signal, a clock signal and digital video data from the system;
a data driving circuit for supplying the digital video data to the liquid crystal panel;
a gate driving circuit for supplying a scan pulse to the liquid crystal panel; and
a timing controller for controlling the data driving circuit and the gate driving circuit by using the synchronous signal and the clock signal from the interface circuit.

21. The apparatus for supplying a power of a liquid crystal display according to claim 19, wherein the DC-DC converter generates a power supply voltage over 6V, gamma reference voltages generated by voltage-dividing the power supply voltage, and a common voltage.
